(19) United States
(12) Patent Application Publication
(10) Pub. No.: US 2019/0074551 A1
(43) Pub. Date: Mar. 7, 2019

(54) ELECTRODE ASSEMBLY FOR SECONDARY BATTERY AND METHOD FOR PRODUCING ELECTRODE ASSEMBLY FOR SECONDARY BATTERY

(71) Applicant: Sumitomo Chemical Company, Limited, Tokyo (JP)

(72) Inventors: Yuichiro AZUMA, Niihama-shi (JP); Daizaburo YASHIKI, Niihama-shi (JP)

(21) Appl. No.: 16/118,413

(22) Filed: Aug. 30, 2018

(30) Foreign Application Priority Data
Sep. 5, 2017 (JP) 2017-170415

(51) Int. Cl. H01M 10/0587; H01M 10/0525

(52) U.S. Cl. CPC H01M 10/0587; H01M 10/0525

(57) ABSTRACT

An electrode assembly for a secondary battery includes: a roll including an electrode sheet and a first separator which are stacked and wound, the first separator including a functional layer and a film base material; and an adhesive tape securing a terminal end portion of the roll on an outer side of the roll. A void which is formed next to an end surface of the first separator is not less than a film thickness of the first separator.

This Nonprovisional application claims priority under 35 U.S.C. § 119 on Patent Application No. 2017-170415 filed in Japan on Sep. 5, 2017, the entire contents of which are hereby incorporated by reference.

### TECHNICAL FIELD

The present invention relates to an electrode assembly for a secondary battery and to a method for producing the electrode assembly for a secondary battery.

### BACKGROUND ART

In a production process for producing an electrode for a secondary battery, a roll in which an electrode sheet and a separator are wound is secured by an adhesive tape or the like at a portion of the roll at which portion the electrode sheet and the separator are wound up. Patent Literature 1 discloses a configuration in which an adhesive tape is attached to a portion of a roll at which portion the roll is wound up.

### CITATION LIST

### Patent Literature

[Patent Literature 1]

Japanese Patent Application Publication, Tokukai, No. 2015-210980 A

### SUMMARY OF INVENTION

### Technical Problem

However, in the roll including a separator disclosed in Patent Literature 1, the adhesive tape is significantly deformed along a step formed by the separator at a terminal end portion of the separator. A functional layer of the separator may break due to being pulled by the adhesive tape which is deformed. Further, in a case where an outermost layer of the roll is an electrode sheet, an active material layer of the electrode sheet may break due to a similar reason.

An object of one aspect of the present invention is to provide an electrode assembly for a secondary battery which electrode assembly suppresses breakage of a functional layer of a separator or breakage of an active material layer of an electrode sheet.

### Solution to Problem

An electrode assembly, in accordance with one aspect of the present invention, for a secondary battery is an electrode assembly for a secondary battery, including: a roll including an electrode sheet and a separator which are stacked, the electrode sheet or the separator being wound, the electrode sheet including an active material layer and a current collector, the separator including a functional layer and a film base material; and an adhesive tape securing a terminal end portion of the roll on an outer side of the roll, the adhesive tape being bonded to an outer surface of the active material layer or an outer surface of the functional layer, next to an end surface of the terminal end portion, a void being formed between the adhesive tape and the electrode sheet or between the adhesive tape and the separator, a length of the void in a circumferential direction of the roll being not less than a film thickness of the electrode sheet or the separator located in an outermost layer of the roll.

A method, in accordance with one aspect of the present invention, for producing an electrode assembly for a secondary battery is a method for producing an electrode assembly for a secondary battery, the electrode assembly including a roll including an electrode sheet and a separator which are stacked, the electrode sheet or the separator being wound, the electrode sheet including an active material layer and a current collector, the separator including a functional layer and a film base material; the method including: a winding step including stacking and winding the electrode sheet and the separator; and an attaching step including securing a terminal end portion of the roll on an outer side of the roll with use of an adhesive tape by bonding the adhesive tape to an outer surface of the active material layer or an outer surface of the functional layer, the attaching step comprising forming, next to an end surface of the terminal end portion, a void between the adhesive tape and the electrode sheet or between the adhesive tape and the separator, a length of the void in a circumferential direction of the roll being not less than a film thickness of the electrode sheet or the separator located in an outermost layer of the roll.

### Advantageous Effects of Invention

According to the one aspect of the present invention, it is possible to suppress breakage of the functional layer of the separator or breakage of the active material layer of the electrode sheet.

### BRIEF DESCRIPTION OF DRAWINGS

(a) of FIG. 1 is a perspective view of an electrode assembly for a secondary battery of an embodiment, in which view the electrode assembly is partially rolled out. (b) and (c) of FIG. 1 are each a perspective view of the electrode assembly for a secondary battery.

FIG. 2 is an enlarged cross-sectional view of a terminal end portion of an outermost layer of a roll in a cross section perpendicular to an axis of the roll, in an electrode assembly of a reference example.

FIG. 3 is enlarged cross-sectional views each illustrating a terminal end portion of an outermost layer of a roll in a cross section perpendicular to an axis of the roll, in an electrode assembly of a reference example.

FIG. 4 is an enlarged cross-sectional view of a terminal end portion of an outermost layer of a roll in a cross section perpendicular to an axis of the roll, in an electrode assembly of an embodiment.

FIG. 5 is a view showing a graph of tan R as an index of deformation.

FIG. 6 is an enlarged cross-sectional view of a terminal end portion of an outermost layer of a roll in a cross section perpendicular to an axis of the roll, in a modified example of the electrode assembly.

FIG. 7 is an image obtained by photographing a cross section of a sample of an electrode assembly.

FIG. 8 is an image obtained by photographing a cross section of a sample of an electrode assembly.

FIG. 9 is an enlarged cross-sectional view of a terminal end portion of an outermost layer of a roll in a cross section perpendicular to an axis of the roll, in an electrode assembly of an embodiment.

FIG. 10 is a schematic cross-sectional view illustrating a configuration of an electrode assembly of an embodiment.

### DESCRIPTION OF EMBODIMENTS

In one aspect of the present invention, a roll which includes (i) an electrode sheet which includes an active material layer and a current collector and (ii) a separator which includes a functional layer and a film base material includes at least (i) a portion where the electrode sheet and the separator overlap with each other and (ii) a portion where the electrode sheet or the separator is wound. That is, the roll may be (i) a roll which is obtained by winding the electrode sheet and the separator together in a state where the electrode sheet and the separator are stacked or (ii) a roll which is obtained by winding at least one of the electrode sheet and the separator around an outermost periphery of a stack of the electrode sheet and the separator so that the at least one of the electrode sheet and the separator runs along the entire outermost periphery at least once.

### Embodiment 1

(a) of FIG. 1 is a perspective view of an electrode assembly for a secondary battery of Embodiment 1, in which view the electrode assembly is partially rolled out. (b) of FIG. 1 is a perspective view of the electrode assembly for a secondary battery. An electrode assembly 1 for a secondary battery includes a roll 2 and an adhesive tape 3 securing a terminal end portion of an outermost layer of the roll 2. The roll 2 includes a negative electrode sheet 4, a positive electrode sheet 5, and two separators (a first separator 6 and a second separator 7). The two electrode sheets (the negative electrode sheet 4 and the positive electrode sheet 5) and the two separators (the first separator 6 and the second separator 7) are alternately stacked, and are wound. A negative electrode lead 4a is connected to the negative electrode sheet 4. A positive electrode lead 5a is connected to the positive electrode sheet 5. The negative electrode lead 4a and the positive electrode lead 5a are configured to be connected to a negative electrode and a positive electrode, respectively, of a secondary battery. The adhesive tape 3 is a tape to be attached to an outer peripheral surface of the roll 2 so as to secure the terminal end portion of the outermost layer of the roll 2 which is rolled up. The adhesive tape 3 may be wound around the roll 2 so as to run along an entire circumference of the roll 2, or may be attached to part of an outer periphery of the roll 2 without being wound so as to run along an entire circumference of the roll 2. Further, the adhesive tape 3 may be attached to a central portion of the roll 2 in an axial direction of the roll 2, or may be attached to a portion other than the central portion. The number of adhesive tape(s) 3 provided may be one, or may be more than one. A width of the adhesive tape 3 (a length of the adhesive tape 3 along the axial direction of the roll 2) may be any length. The width may be a length which allows the adhesive tape 3 to cover almost an entire width of the roll 2 along the axial direction of the roll 2, or may be a length which allows the adhesive tape 3 to cover part of the width of the roll 2 along the axial direction of the roll 2. The electrode assembly 1 is contained inside a battery can in order to constitute a secondary battery. Note that a length and a width of each of the negative electrode sheet 4, the positive electrode sheet 5, the first separator 6, and the second separator 7 illustrated in (a) of FIG. 1 are schematically shown and are not precise. The roll 2 illustrated in FIG. 1 may have a cylindrical shape in order to be contained inside a cylindrical battery can, or may have a flattened cylindrical shape, as illustrated in (c) of FIG. 1, in order to be contained inside a rectangular parallelepiped or bag-like battery container. A container in which the roll 2 is contained is not limited to a metal can, and may be a bag-like or box-like container into which a film that is a stack of resin and a metal foil is molded.

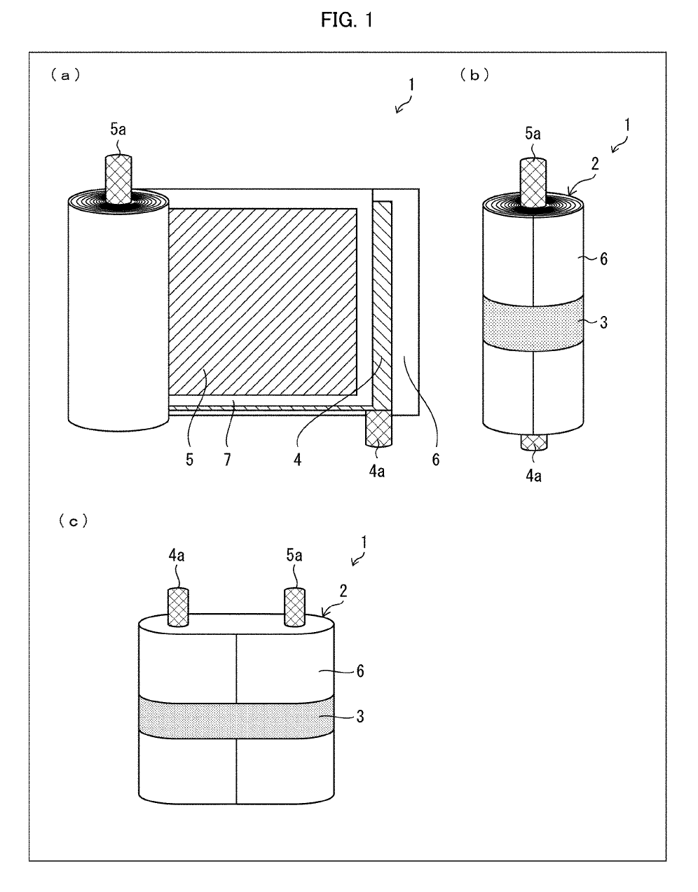

FIG. 2 is an enlarged cross-sectional view of a terminal end portion of an outermost layer of a roll in a cross section perpendicular to an axis of the roll, in an electrode assembly of Reference Example. A first separator 6 is located in the outermost layer of the roll. The first separator 6 includes a porous film base material 11 and a functional layer 12. Although the functional layer 12 in this example is provided on one surface of the porous film base material 11, the functional layer 12 may be provided on both surfaces of the porous film base material 11. The functional layer 12 is made of a material that is more fragile than the porous film base material 11 which is flexible.

The first separator 6 includes, for example, a heat-resistant layer as the functional layer 12. When a temperature of the first separator 6 is raised, the porous film base material 11 of the first separator 6 melts so as to block pores formed in the porous film base material 11. Through this, the film base material 11 stops movement of lithium ions and prevents overdischarge or overcharge of the secondary battery. Meanwhile, the heat-resistant layer does not undergo a change in shape even when the temperature of the first separator 6 is raised. That is, even in a case where the porous film base material 11 melts, the heat-resistant layer maintains a film shape of the first separator 6 without undergoing a change in shape. This allows reliably stopping movement of lithium ions.

The adhesive tape 3 includes a tape base material 13, which is a plastic film or the like, and an adhesive layer 14 for bonding. The adhesive layer 14 mainly contains an adhesive agent (or a bonding agent), and is provided on an inner surface of the tape base material 13. The first separator 6 is thinner and more flexible as compared with the adhesive tape 3 (especially as compared with the tape base material). The adhesive layer 14 is softer than the tape base material 13. Accordingly, the adhesive layer 14 is significantly deformed around a step formed by the terminal end portion of the first separator 6, and is bonded to an outer surface of the first separator 6.

In a step of attaching the adhesive tape 3, in order to prevent loosening of the rolled-up state of the roll, the adhesive tape 3 is attached, in a circumferential direction (a direction indicated by an arrow I), to a portion of the first separator 6 which portion is in the outermost layer (on an upper side in FIG. 2) and then to a portion of the first separator 6 which portion is on an inner side (on a lower side in FIG. 2). Note that, in order to distinguish a portion of the first separator 6 which portion is located higher than the step formed by the terminal end portion of the first separator 6 and a portion of the first separator 6 which portion is located lower than the step, the former is herein referred to as a first separator 6 in the outermost layer and the latter is herein referred to as a first separator 6 on an inner side. The adhesive tape 3 is bonded to an outer surface of the functional layer 12 at the terminal end portion of the first separator 6 in the outermost layer. A void 15 is formed next to an end surface 16 of the terminal end portion of the first separator 6 in the outermost layer.

As compared to the adhesive layer 14, the tape base material 13 hardly becomes deformed. Accordingly, a portion of the adhesive layer 14 which portion is adjacent to the void 15 is stretched along a direction in which a surface of the adhesive layer 14 extends. In a case where an angle R between the first separator 6 on the inner side and the adhesive layer 14, which sandwich the void 15 therebetween, is large, it is indicated that the adhesive layer 14 is deformed by a large deformation amount (deformation is significant) in a circumferential direction (a direction along the tape base material 13). In the case where the angle R between the first separator 6 on the inner side and the adhesive layer 14, which sandwich the void 15 therebetween, is large, a tip of the functional layer 12 of the first separator 6 in the outermost layer is pulled mainly in the circumferential direction (the direction indicated by the arrow I). This may cause the functional layer 12 in the outermost layer to be peeled off from the film base material 11 or break at the terminal end portion, and accordingly cause a bit of the functional layer 12 to fall off from the end surface 16 of the first separator 6.

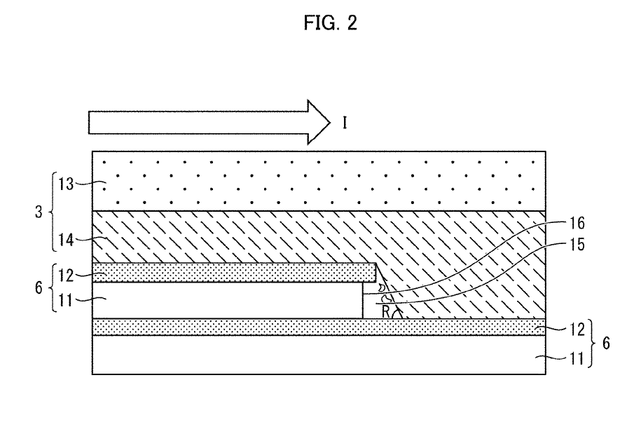

(a) and (b) of FIG. 3 are enlarged cross-sectional views each illustrating the terminal end portion of the outermost layer of the roll in a cross section perpendicular to the axis of the roll, in the electrode assembly of Reference Example. Contraction stress has been generated in the adhesive layer 14 which is deformed (stretched). Accordingly, the adhesive layer 14 which is deformed is pulling the functional layer 12 of the first separator 6 on the inner side toward the tape base material 13. Particularly, in a case where the angle R between the functional layer 12 of the first separator 6 on the inner side and the adhesive layer 14, which sandwich the void 15 therebetween, is large ((a) of FIG. 3), a portion of the adhesive layer 14 which portion corresponds to the void 15 is significantly stretched, and contraction stress of the adhesive layer 14 is also significant, accordingly. As such, in a case where the adhesive layer 14 which is deformed pulls the functional layer 12 of the first separator 6 on the inner side toward the tape base material 13, the functional layer 12 of the first separator 6 on the inner side may be peeled off from the film base material 11 ((b) of FIG. 3).

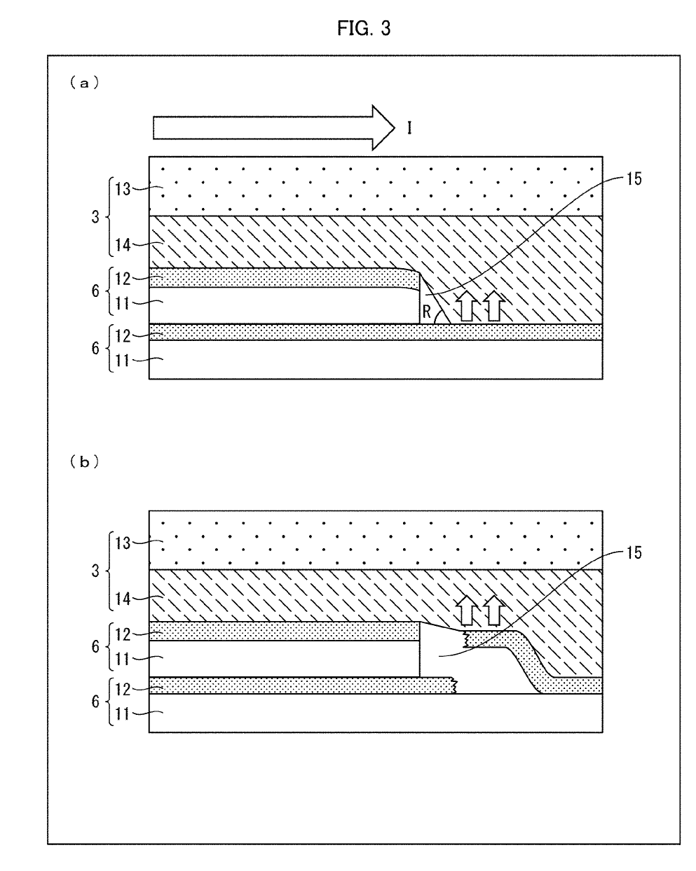

FIG. 4 is an enlarged cross-sectional view of the terminal end portion of the outermost layer of the roll 2 in a cross section perpendicular to the axis of the roll 2, in the electrode assembly 1 of Embodiment 1. The electrode assembly 1 is identical to the electrode assembly of Reference Example except that the angle R is small. The first separator 6 is located in the outermost layer of the roll 2. In the first separator 6, a functional layer 12 is provided on an outer surface of a film base material 11. An adhesive layer 14 of the adhesive tape 3 is bonded to an outer surface of the functional layer 12. The adhesive layer 14 is thin at a portion corresponding to the first separator 6 located in the outermost layer, and is thick at a portion corresponding to the first separator 6 on the inner side. That is, the portion of the adhesive layer 14 which portion corresponds to the first separator 6 located in the outermost layer is compressed in a diametral direction of the roll 2, and the portion of the adhesive layer 14 which portion corresponds to the first separator 6 on the inner side is stretched in the diametral direction of the roll 2. Accordingly, a force toward an inner side of the roll 2 is exerted from the adhesive layer 14 to the first separator 6 located in the outermost layer, and a force toward an outer side of the roll 2 is exerted from the adhesive layer 14 to the first separator 6 on the inner side.

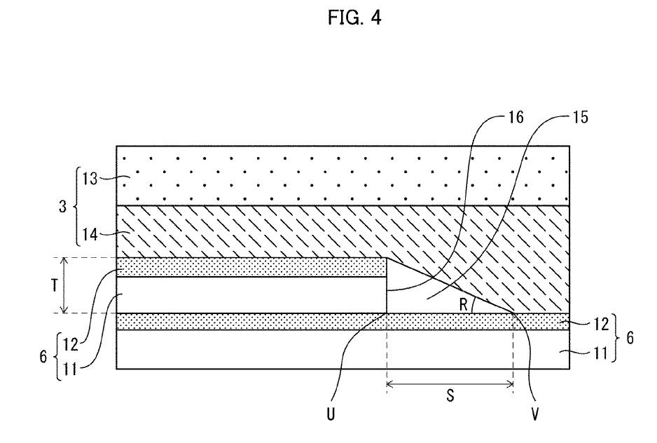

In the electrode assembly 1, a void 15 next to an end surface 16 of the terminal end portion of the first separator 6 is formed in an intentionally large size. In the electrode assembly 1, a length S of the void 15 in the circumferential direction of the roll 2 is not less than a film thickness T of the first separator 6 located in the outermost layer of the roll 2. Setting the length S of the void 15 not less than the film thickness T of the first separator 6 located in the outermost layer allows the angle R between the first separator 6 on the inner side and the adhesive layer 14, which sandwich the void 15 therebetween, to be not more than 45°. This reduces deformation of the adhesive layer 14 around the void 15. In terms of reducing deformation of the adhesive layer 14, the greater the length S relative to the film thickness T, the better. The following will discuss the length S of the void 15 in more detail with reference to FIG. 4. The length S of the void 15 means a distance between (i) a lower end U of the end surface 16 of the terminal end portion of the first separator 6 in the outermost layer and (ii) a bonding end V at which the adhesive layer 14 of the adhesive tape 3 is bonded to the first separator 6 on the inner side. In a case where the film thickness T is 1, the length S relative to the film thickness T is preferably not less than 2, and may be not less than 5, not less than 10, or not less than 50. Further, the length S relative to the film thickness T may be not more than 200 or not more than 100. In a case where a ratio T/S is close to 0, deformation of the adhesive layer 14 is close to 0. As such, tan R serves as an index of a scale of deformation of the adhesive layer 14. FIG. 5 is a view showing a graph of tan R as an index of deformation. As indicated in FIG. 5, a slope of the graph shows a sharp increase after R exceeds 45°. In Embodiment 1, the adhesive tape 3 is attached so as to satisfy R≤45° by avoiding an angle range (R>45°) where deformation is sharply increased. This enables suppressing deformation of the adhesive layer 14. Accordingly, contraction stress of the adhesive layer 14 around the void 15 is also small. This enables the functional layer 12 of the first separator 6 on the inner side from being peeled off. Further, stress of the adhesive layer 14 along the circumferential direction (the direction along the tape base material 13) is also small. This enables preventing the functional layer 12 in the outermost layer from being peeled off from the film base material 11 or breaking, at the terminal end portion of the first separator 6 in the outermost layer.

Note that although the above description discussed a configuration in which the functional layer 12 is provided on one surface of the film base material 11, the functional layer 12 may be provided on both surfaces of the film base material 11.

Note that the end surface 16 of the terminal end portion of the first separator 6 in the outermost layer may be tilted with respect to an outer surface of the terminal end portion of the first separator 6 in the outermost layer. For example, the terminal end portion of the first separator 6 in the outermost layer may be configured such that, in a cross section perpendicular to the axis of the roll 2, an internal angle of the terminal end portion on an adhesive tape 3 side (on an outer side) is an obtuse angle. Alternatively, the terminal end portion of the first separator 6 in the outermost layer may be configured such that, in the cross section perpendicular to the axis of the roll 2, the internal angle of the terminal end portion on the adhesive tape 3 side (on the outer side) is an acute angle. For example, a long separator which has been produced is obliquely cut with use of a cutting blade, so that end surfaces of separators thus cut are inclined surfaces.

The electrode assembly 1 can be produced in the following manner. In a winding step, the two electrode sheets (the negative electrode sheet 4 and the positive electrode sheet 5) and the two separators (the first separator 6 and the second separator 7) are alternately stacked and are wound so as to produce the roll 2. In an attaching step, the adhesive tape 3 is attached to the first separator 6 (on an upper side in FIG. 4) in the outermost layer and then is attached to the first separator 6 (on a lower side in FIG. 4) on an immediately inner side of the first separator 6 in the outermost layer. The adhesive tape 3 is bonded to the outer surface of the functional layer 12 at the terminal end portion of the first separator 6. Subsequently, a portion (a portion on the right of the end surface 16 in FIG. 4) located lower than the step formed by the terminal end portion of the first separator 6 in the outermost layer is pressed by a pressing member over the adhesive tape 3. At this time, in order to prevent the pressing member from causing the void 15 to be removed, the pressing member is prevented from pressing an area within a predetermined distance from the end surface 16 of the terminal end portion of the first separator 6 in the outermost layer. In other words, a portion which is away from the end surface 16 of the terminal end portion by the predetermined distance is pressed with use of the pressing member. This enables intentionally forming the void 15 in a large size.

### Modified Example

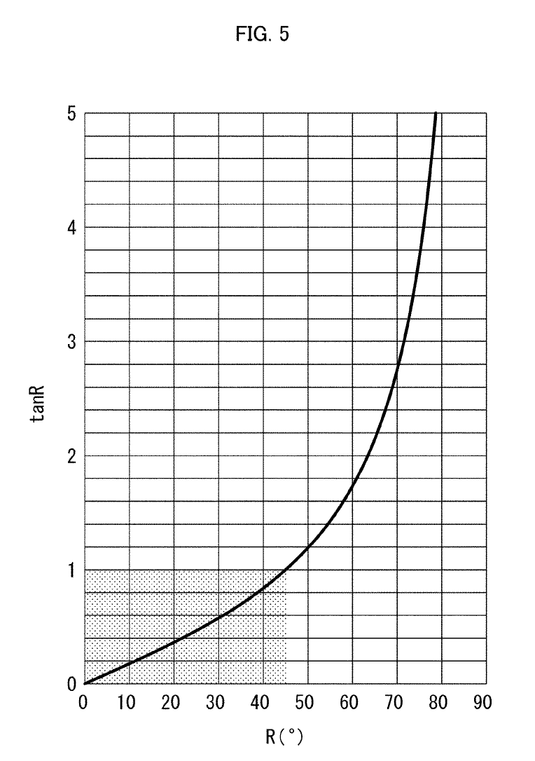

FIG. 6 is cross-sectional views each illustrating a terminal end portion of an outermost layer in a cross section perpendicular to an axis of a roll in Modified Example of the electrode assembly involving various directions which a functional layer 12 faces. In FIG. 6, a portion within a broken line is a portion in which breakage of the functional layer 12 is prevented by an effect of one aspect of the present invention.

In an electrode assembly illustrated in (a) of FIG. 6, both of (i) a functional layer 12 of a first separator 6 in the outermost layer and (ii) a functional layer 12 of a first separator 6 on an immediately inner side of the first separator 6 in the outermost layer face outward (an adhesive tape 3 side). According to this configuration, by forming a void 15 which satisfies S≥T (or R≤45°), it is possible to prevent breakage of the functional layer 12 of the first separator 6 in the outermost layer and breakage of the functional layer 12 of the first separator 6 on the immediately inner side.

In an electrode assembly illustrated in (b) of FIG. 6, a functional layer 12 of a first separator 6 in the outermost layer faces inward (on a side of the axis of the roll), and a functional layer 12 of a second separator 7 on an immediately inner side of the first separator 6 in the outermost layer faces outward (an adhesive tape 3 side). According to this configuration, by forming a void 15 which satisfies S≥T (or R≤45°), it is possible to prevent breakage of the functional layer 12 of the second separator 7 on the immediately inner side. Note that a terminal end portion of the second separator 7 on the immediately inner side is secured at another spot by an adhesive tape 3.

In an electrode assembly illustrated in (c) of FIG. 6, a functional layer 12 of a first separator 6 in the outermost layer faces outward (an adhesive tape 3 side), and a functional layer 12 of a second separator 7 on an immediately inner side of the first separator 6 in the outermost layer faces inward (on a side of the axis of the roll). According to this configuration, by forming a void 15 which satisfies S≥T (or R≤45°), it is possible to prevent breakage of the functional layer 12 of the first separator 6 in the outermost layer. Note that a terminal end portion of the second separator 7 on the immediately inner side is secured at another spot by an adhesive tape 3.

Note that, in a case where the film base material 11 of the first separator 6 in the outermost layer faces outward (the adhesive tape 3 side) as illustrated in (b) of FIG. 6, the adhesive tape 3 is bonded to the film base material 11 of the first separator 6. As such, there is no need to be concerned that the adhesive tape 3 may break the functional layer 12 of the first separator 6. However, the functional layer 12 of the first separator 6 faces a direction that is opposite to a direction which the functional layer 12 of the second separator 7 faces. Accordingly, in a process for producing an electrode assembly, an operator is more prone to mistake a direction in which a separator roll, which is a material, is set to an axis.

Meanwhile, in (a) of FIG. 6, both of the functional layer 12 of the first separator 6 in the outermost layer and the functional layer 12 of the first separator 6 on the immediately inner side face outward (the adhesive tape 3 side). In this case, in a process for producing an electrode assembly, an operator is less prone to mistake a direction in which a separator roll, which is a material, is set to an axis, since the direction is the same between the functional layer 12 of the first separator 6 and the functional layer 12 of the second separator 7. Further, in the example above, a void 15 which satisfies S≥T (or R≤45°) is formed, so that breakage of the functional layers 12 which faces outward is suppressed.

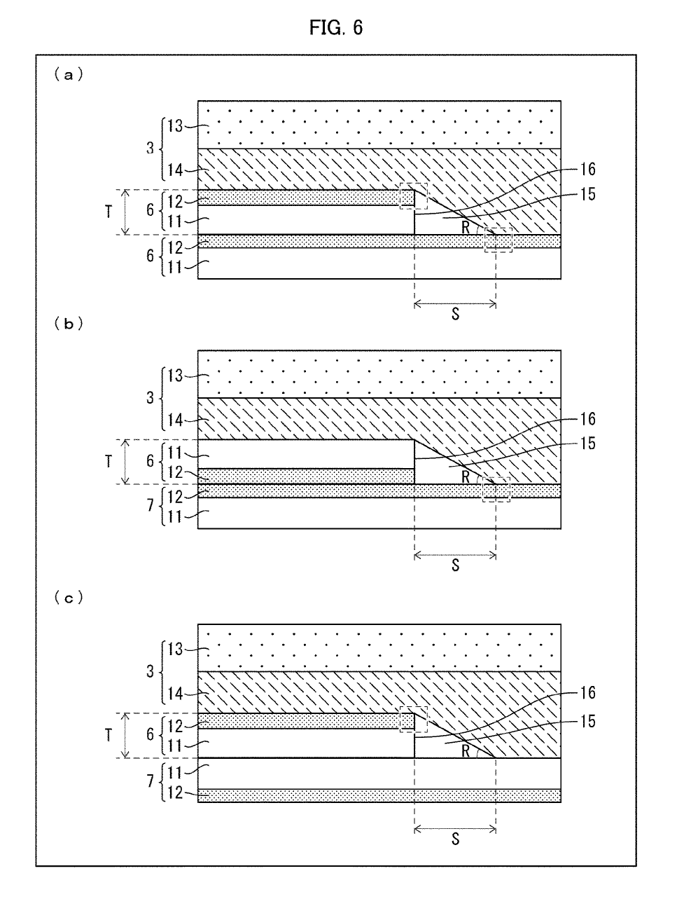

FIG. 7 is an image obtained by photographing a cross section of a sample of an electrode assembly corresponding to the configuration illustrated in FIG. 5. For visibility, lines are added to indicate an interface between an adhesive layer 14 and a tape base material 13 and an interface between the adhesive layer 14 and a separator. In this example, only a terminal end portion to which an adhesive tape 3 was attached was taken and photographed with use of a laser microscope. Accordingly, a space is formed between a first separator 6 and a second separator 7 at a portion far from an end surface 16. Note that a functional layer of the first separator 6 and a functional layer of the second separator 7 face an adhesive tape 3 side.

As shown in FIG. 7, the end surface 16 of the terminal end portion of the first separator 6 is inclined with respect to an outer surface of the terminal end portion of the first separator 6. Specifically, an internal angle of the terminal end portion of the first separator 6 on an adhesive tape 3 side (on an outer side) is an obtuse angle. A void 15 which satisfies S≥T (or R≤45°) is formed next to the end surface 16 which is inclined.

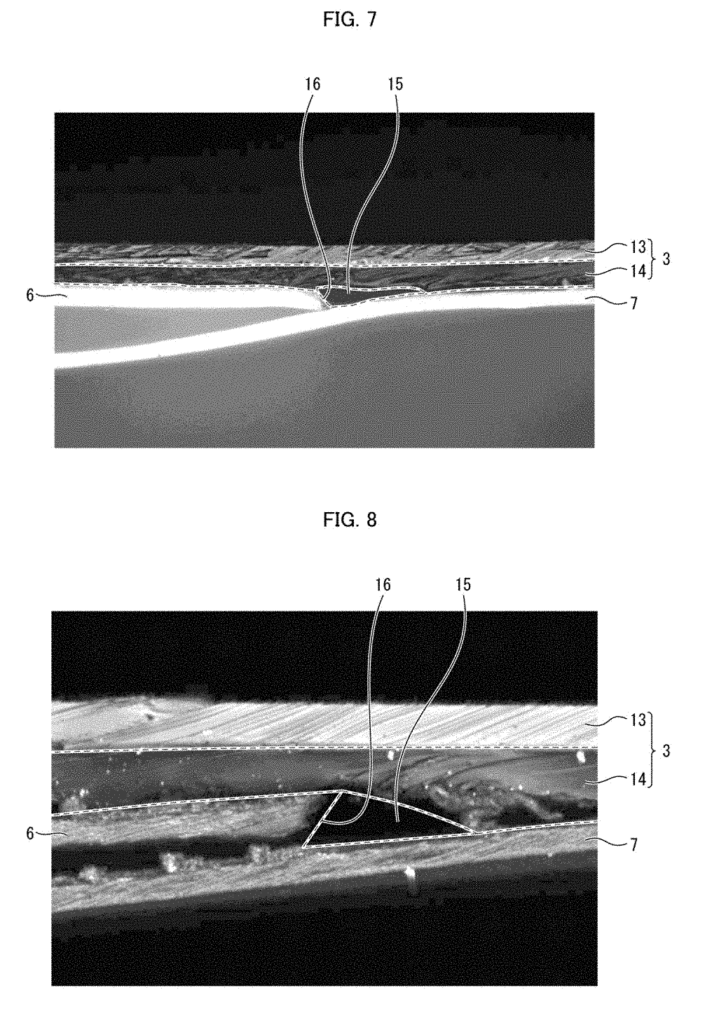

FIG. 8 is an image obtained by photographing a cross section of a sample of another electrode assembly. For visibility, lines are added to indicate an interface between an adhesive layer 14 and a tape base material 13 and an interface between the adhesive layer 14 and a separator. In this example, only a terminal end portion to which an adhesive tape 3 was attached was taken and photographed with use of a laser microscope. Note that a functional layer of a first separator 6 and a functional layer of a second separator 7 face an adhesive tape 3 side.

Inclination of the end surface 16 in the electrode assembly illustrated in FIG. 8 is reverse to inclination of the end surface 16 in the electrode assembly illustrated in FIG. 7. Specifically, an internal angle of the terminal end portion of the first separator 6 on an adhesive tape 3 side is an acute angle. A void 15 which satisfies S≥T (or R≤45°) is formed next to the end surface 16 which is inclined.

### Embodiment 2

The following description will discuss Embodiment 2 of the present invention. For easy explanation, the same reference signs will be given to members having the same function as a member described in Embodiment 1, and descriptions on such a member will be omitted. In Embodiment 1, an example has been discussed in which example an outermost layer of a roll is a separator. In Embodiment 2, an example will be discussed in which example an outermost layer of a roll is an electrode sheet.

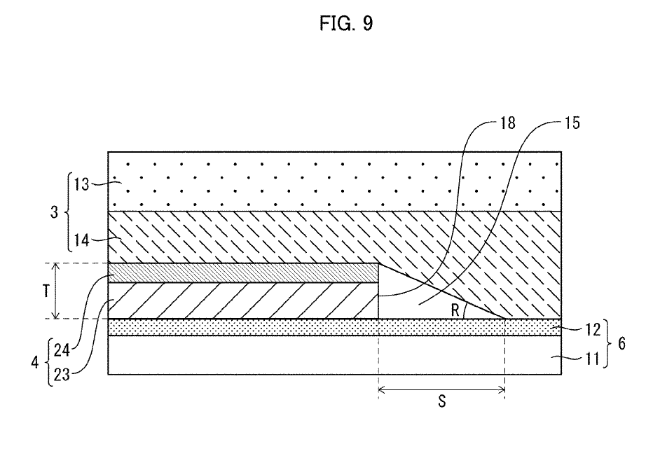

FIG. 9 is an enlarged cross-sectional view illustrating a terminal end portion of an outermost layer of a roll in a cross section perpendicular to an axis of the roll in an electrode assembly of Embodiment 2. In the electrode assembly of Embodiment 2, a negative electrode sheet 4 is located in the outermost layer of the roll. The negative electrode sheet 4 includes a negative electrode current collector 23, which is a metal conductive foil, and a negative electrode active material layer 24, which is provided on the negative electrode current collector 23. In this example, the negative electrode active material layer 24 is formed by being applied onto the negative electrode current collector 23, and is made of a material which is more fragile than that of the negative electrode current collector 23. Similarly, although not illustrated, the positive electrode sheet includes a positive electrode current collector, which is a metal conductive foil, and a positive electrode active material layer which is provided on the positive electrode current collector. The negative electrode active material layer 24 of the negative electrode sheet 4 in the outermost layer faces outward (an adhesive tape 3 side), and a functional layer 12 of a first separator 6 on an inner side also faces outward (the adhesive tape 3 side).

In this configuration, too, a void 15 next to an end surface 18 of a terminal end portion of the negative electrode sheet 4 is formed in an intentionally large size. Specifically, a length S of the void 15 in a circumferential direction of the roll is not less than a film thickness T of the negative electrode sheet 4 located in the outermost layer of the roll 2. That is, an angle R between the first separator 6 on the inner side and the adhesive layer 14, which sandwich the void 15 therebetween, is not more than 45°. This reduces deformation of the adhesive layer 14 around the void 15. Accordingly, contraction stress of the adhesive layer 14 is also small. This enables preventing the functional layer 12 of the first separator 6 on the inner side from being peeled off. Further, at a tip of the negative electrode active material layer 24 of the negative electrode sheet 4, the adhesive layer 14 is compressed mainly in a diametral direction of the roll. Accordingly, a force toward an inner side of the roll is mainly applied to the tip of the negative electrode active material layer 24 of the negative electrode sheet 4. This enables preventing the negative electrode active material layer 24 from being peeled off from the negative electrode current collector 23 or breaking, at the terminal end portion of the negative electrode sheet 4.

Thus, even in a case of a configuration in which the negative electrode sheet 4 or the positive electrode sheet 5 is exposed to an outer side of the roll, it is possible to form a void 15 which satisfies S≥T (or R≤45°). In the above-described configurations of Embodiment 1, the first separator 6 or the second separator 7 may be replaced with the negative electrode sheet 4 or the positive electrode sheet 5. Note, however, that it is necessary that the electrode sheets and the separators be arranged so that the first separator 6 or the second separator 7 is interposed between the negative electrode sheet 4 and the positive electrode sheet 5.

Note that the above description has discussed a configuration in which an active material layer is provided on one surface of a metal conductive foil of an electrode sheet of each of the positive electrode and the negative electrode, but the active material layer may be provided on both surfaces of the metal conductive foil.

### Embodiment 3

The following description will discuss Embodiment 3 of the present invention. For easy explanation, the same reference signs will be given to members having the same function as a member described in each of Embodiments 1 and 2, and descriptions on such a member will be omitted.

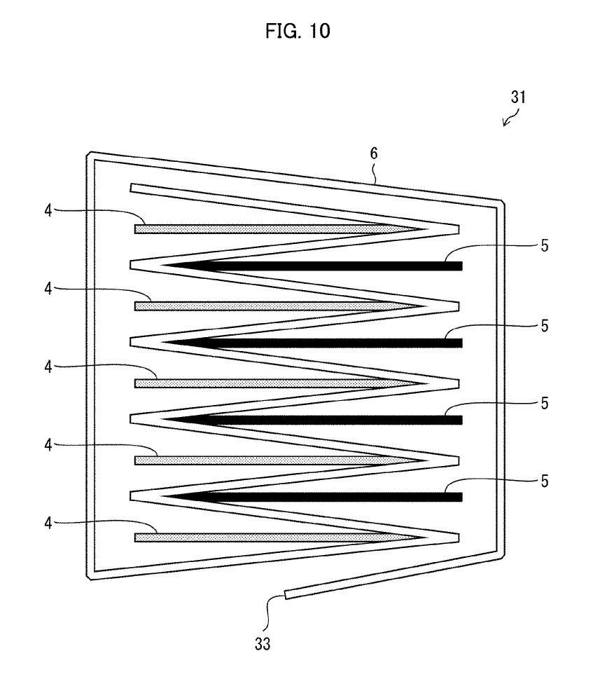

FIG. 10 is a cross-sectional view schematically illustrating a configuration of an electrode assembly of Embodiment 3. A roll 31 of Embodiment 3 includes a first separator 6, a plurality of negative electrode sheets 4, and a plurality of positive electrode sheets 5. The plurality of negative electrode sheets 4 and the plurality of positive electrode sheets 5 are alternately stacked, and the first separator 6 is passed through between each adjacent electrode sheets. The first separator 6 is wound around an outermost periphery of a stack of the first separator 6, the plurality of negative electrode sheets 4, and the plurality of positive electrode sheets 5. An adhesive tape (not illustrated) is attached to an outer peripheral surface of the roll 31 in order to secure a terminal end portion 33 of an outermost layer of the roll 31.

The present invention is not limited to the embodiments, but can be altered by a skilled person in the art within the scope of the claims. The present invention also encompasses, in its technical scope, any embodiment derived by combining technical means disclosed in differing embodiments.

[Recap]

An electrode assembly, in accordance with one aspect of the present invention, for a secondary battery is an electrode assembly for a secondary battery, including: a roll including an electrode sheet and a separator which are stacked, the electrode sheet or the separator being wound, the electrode sheet including an active material layer and a current collector, the separator including a functional layer and a film base material; and an adhesive tape securing a terminal end portion of the roll on an outer side of the roll, the adhesive tape being bonded to an outer surface of the active material layer or an outer surface of the functional layer, next to an end surface of the terminal end portion, a void being formed between the adhesive tape and the electrode sheet or between the adhesive tape and the separator, a length of the void in a circumferential direction of the roll being not less than a film thickness of the electrode sheet or the separator located in an outermost layer of the roll.

According to the above configuration, since the length of the void is not less than the film thickness of the electrode sheet or the separator located in the outermost layer of the roll, it is possible to suppress breakage of the active material layer or the functional layer which breakage may otherwise be caused in a case where the adhesive tape pulls the active material layer or the functional layer.

The electrode assembly may be configured such that an outermost layer of the roll is the separator.

A method, in accordance with one aspect of the present invention, for producing an electrode assembly for a secondary battery is a method for producing an electrode assembly for a secondary battery, the electrode assembly including a roll including an electrode sheet and a separator which are stacked, the electrode sheet or the separator being wound, the electrode sheet including an active material layer and a current collector, the separator including a functional layer and a film base material; the method including: a winding step including stacking and winding the electrode sheet and the separator; and an attaching step including securing a terminal end portion of the roll on an outer side of the roll with use of an adhesive tape by bonding the adhesive tape to an outer surface of the active material layer or an outer surface of the functional layer, the attaching step comprising forming, next to an end surface of the terminal end portion, a void between the adhesive tape and the electrode sheet or between the adhesive tape and the separator, a length of the void in a circumferential direction of the roll being not less than a film thickness of the electrode sheet or the separator located in an outermost layer of the roll.

According to the above method, since the length of the void in the circumferential direction of the roll is not less than the film thickness of the electrode sheet or the separator located in the outermost layer of the roll, it is possible to suppress breakage of the active material layer or the functional layer which breakage may otherwise be caused in a case where the adhesive tape pulls the active material layer or the functional layer.

Further, the method may be configured such that an outermost layer of the roll is the separator.

### REFERENCE SIGNS LIST

1 electrode assembly
2, 31 roll
3 adhesive tape
4 negative electrode sheet (electrode sheet)
5 positive electrode sheet (electrode sheet)
6 first separator (separator)
7 second separator (separator)
11 film base material
12 functional layer
13 tape base material
14 adhesive layer
15 void
16, 18 end surface
23 negative electrode current collector (current collector)
24 negative electrode active material layer (active material layer)
R angle
S length
T film thickness
U lower end of terminal end portion of first separator in outermost layer
V bonding end

1. An electrode assembly for a secondary battery, comprising:
a roll including an electrode sheet and a separator which are stacked, the electrode sheet or the separator being wound, the electrode sheet including an active material layer and a current collector, the separator including a functional layer and a film base material; and
an adhesive tape securing a terminal end portion of the roll on an outer side of the roll,
the adhesive tape being bonded to an outer surface of the active material layer or an outer surface of the functional layer,
next to an end surface of the terminal end portion, a void being formed between the adhesive tape and the electrode sheet or between the adhesive tape and the separator,
a length of the void in a circumferential direction of the roll being not less than a film thickness of the electrode sheet or the separator located in an outermost layer of the roll.

2. The electrode assembly as set forth in claim 1, wherein the outermost layer of the roll is the separator.

3. A method for producing an electrode assembly for a secondary battery,
the electrode assembly including a roll including an electrode sheet and a separator which are stacked, the electrode sheet or the separator being wound, the electrode sheet including an active material layer and a current collector, the separator including a functional layer and a film base material;
the method comprising:
a winding step comprising stacking and winding the electrode sheet and the separator; and
an attaching step comprising securing a terminal end portion of the roll on an outer side of the roll with use of an adhesive tape by bonding the adhesive tape to an outer surface of the active material layer or an outer surface of the functional layer,
the attaching step comprising forming, next to an end surface of the terminal end portion, a void between the adhesive tape and the electrode sheet or between the adhesive tape and the separator,
a length of the void in a circumferential direction of the roll being not less than a film thickness of the electrode sheet or the separator located in an outermost layer of the roll.

4. The method as set forth in claim 3, wherein the outermost layer of the roll is the separator.
